(19) United States
(12) Patent Application Publication
(10) Pub. No.: US 2007/0251972 A1
(43) Pub. Date: Nov. 1, 2007

(54) Restriction mechanism for managing trigger of pneumatic nailers

(75) Inventor: Yi-Kuan Lee, Ta-Li City (TW)

Correspondence Address: CHARLES E. BAXLEY, ESQ., 90 JOHN STREET, THIRD FLOOR, NEW YORK, NY, 10038, US

(73) Assignee: Samson Power Tool Co., Ltd.

(21) Appl. No.: 11/787,508

(22) Filed: Apr. 17, 2007

(30) Foreign Application Priority Data
Apr. 17, 2006 (TW) 095113729

(51) Int. Cl. B25C 1/04

(52) U.S. Cl. 227/130

(57) ABSTRACT

A restriction mechanism for a pneumatic nailer includes a secondary valve unit including a second axle with a seal ring mounted thereto and the second axle is movable along a hollow axial passage of the second frame. A second frame includes an annular portion, the hollow axial passage and guide holes. A seal ring is mounted to the annular portion and the second chamber communicates with the hollow axial passage via the guide holes. The seal ring on the second axle removably seals the hollow axial passage to control communication between the second frame and the second axle. The second valve unit has to be pulled before pulling the trigger to shoot the nail. The sequence cannot be reverse so as to form a safety operation mechanism.

### FIELD OF THE INVENTION

The present invention relates to a restriction mechanism which ensures the trigger to be effectively pulled only when a secondary valve is pulled.

### BACKGROUND OF THE INVENTION

A conventional trigger mechanism for a pneumatic nailer “A” is shown in FIGS. 1 and 12, and generally includes a chamber 10 defined in a barrel 1 of the nailer “A” and a cylinder 24 is received in the chamber 10, a piston unit 25 is movably received in the cylinder 24. A spring 21 and a frame 22 are located between an end cap 2 and a rear end of the cylinder 24. The upper end and the lower end of the frame 22 in FIGS. 1 and 3 are respectively located at an entrance of the upper path 15 and the entrance of the main path 11. A trigger unit 3 is connected to the handle of the nailer “A” and includes an end member 30, an axle 31 and two seals 32, wherein the end member 30 is received in the recess 12 of the handle and includes axle hole 301 and escape holes 302. The axle 31 with the seals 32 are movable between the axle hole 301 and the two respective entrances of the main path 11 and the upper path 15 so as to removably seal the two respective entrances and the inner side of the end member 30.

When the axle 31 of the trigger unit 3 is pulled by the plate 40 of the trigger 4 and the seal 32 on the upper section of the axle 31 seals the entrance and the seal 32 on the lower section of the axle 31 is separated from the end member 30 so that the upper path 15 communicates with the escape holes 302. The compressed air in the upper path 15 escapes from the escape holes 302, such that the pressure in the upper path 15 decreases. The sum of the pressure on the frame 22 and the force applied by the spring 21 is less than the pressure beneath the frame 22, so that the frame 22 is pushed upward and the compressed air enters into the cylinder 24 to push the piston unit 25 at high speed to eject a nail.

When the barrel 1 is removed from the object and the safety rod 5 moves downward, the plate 40 is then removed from the axle 31 until the seal 32 on the lower section of the axle 31 is in contact with the inside of the end member 30. in other words, the upper path 15 and the escape holes 302 are not in communication with each other, the compressed air in the main path 11 enters the space above the frame 22 via the upper path 15 and the frame 22 is pushed downward further by the force from the spring 21 till the underside of the frame 22 is in contact with the rear end of the cylinder 24. Therefore, the compressed air in the upper path 15 in the barrel 1 enters into the cylinder 24 and pushes the piston unit 25 to its ready-to-shoot position. If the barrel 1 is pushed against an object again, the plate 40 is moved to the axle 31 and the axle 31 can be pushed to shoot as the user pulls the trigger 4.

However, the conventional mechanism cannot restrict the sequence of the pull of the trigger 4 and the safety rod 5, in other words, even if the user holds the trigger first and the safety rod 5 unintentionally touches an object, the nail is ejected. This might cause dangerous result to hurt people.

The present invention intends to provide a restriction mechanism which ensures the user to pull the secondary axle of a secondary valve unit first then to pull the trigger to shoot the nail.

### SUMMARY OF THE INVENTION

The present invention relates to a restriction mechanism for a pneumatic nailer includes a main path, a first chamber and an upper path defined in a handle. A second chamber is defined in the handle and communicates with the first chamber. A main valve unit is received in the first chamber and includes a first axle on which a seal is mounted. The first axle is movable to move the seal to seal an through hole of the main valve unit so as to control communication between an entrance of the upper path and a first inlet of first chamber, and between the entrance of the upper path and a second inlet of second chamber. A secondary valve unit is received in the second chamber and includes a second end member, a second frame and a second axle. The second end member has a seal ring mounted thereon and is in contact with an inside of the secondary chamber. The second end member includes a second axle hole and second escape holes. The second axle has a seal ring mounted thereto and is movable along a hollow axial passage of the second frame and within a second axle hole of the secondary valve unit. The second frame includes an annular portion, the hollow axial passage and guide holes. A seal ring is mounted to the annular portion and a space is defined between the annular portion and the second end member or the inside of the second chamber. The second chamber communicates with the hollow axial passage via the guide holes. The seal ring on the second axle removably seals the hollow axial passage to control communication between the second frame and the second axle.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a conventional trigger mechanism of a pneumatic nailer;

FIG. 2 shows that the conventional trigger mechanism is pulled;

FIG. 3 shows the restriction mechanism of the present invention;

FIG. 4 shows that the secondary valve unit is first pulled;

FIG. 5 shows that the main valve unit is then pulled;

FIG. 6 shows the main valve unit is pulled after the secondary valve unit is pulled;

FIG. 7 shows the main valve unit is pulled while the secondary valve unit is not yet pulled;

FIG. 8 shows the secondary valve unit is then pulled;

FIG. 9 shows another embodiment of the secondary valve unit, and

FIG. 10 shows yet another embodiment of the secondary valve unit.

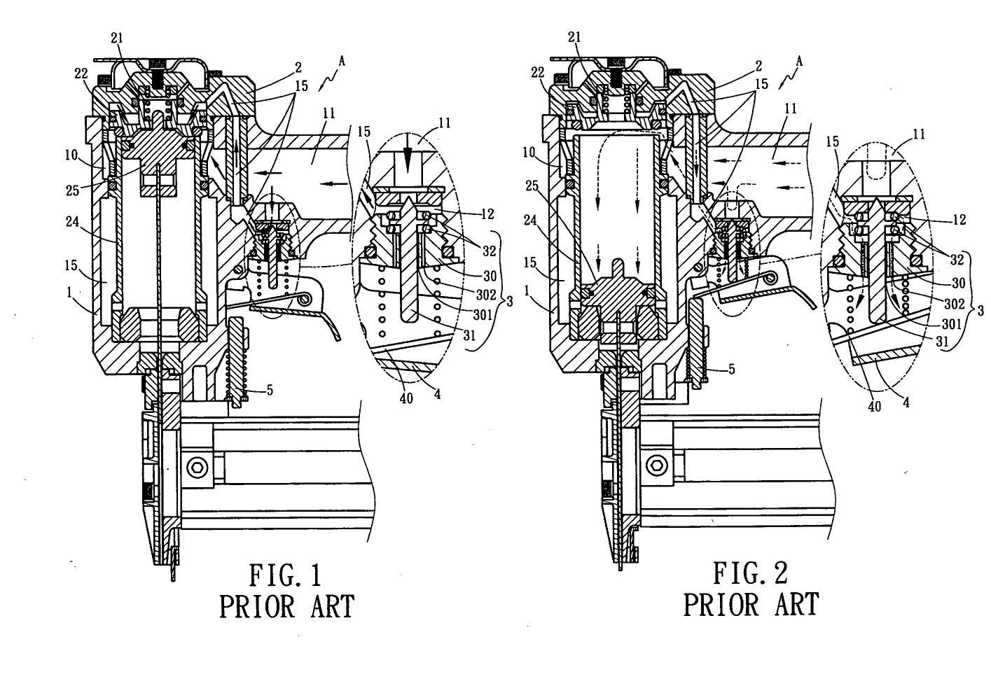

### DETAILED DESCRIPTION OF THE PREFERRED EMBODIMENT

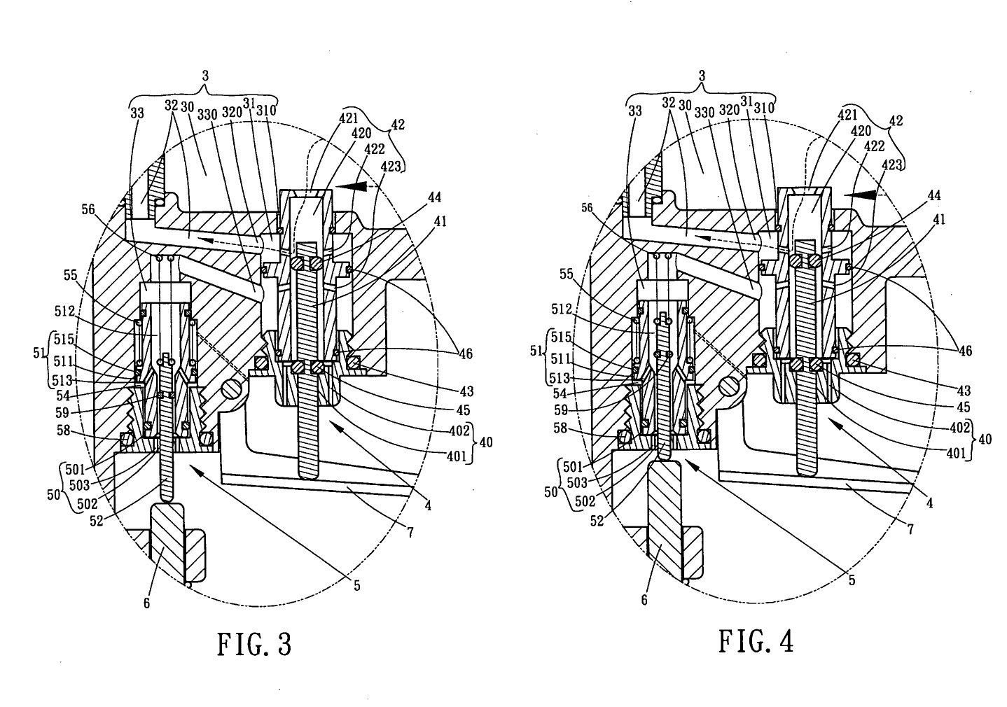

Referring to FIGS. 3 to 8, the restriction mechanism of the present invention for a pneumatic nailer comprises a main path 30, a first chamber 31, an upper path 32 and a second chamber 33 defined in a handle 3 of the pneumatic nailer. The first chamber 31 communicates with the main path 30, the first chamber 31 and the upper path 32. The second chamber 33 is located beside the first chamber 31.

A main valve unit 4 is received in the first chamber 31 and includes a first end member 40, a first axle 41 and a first frame 42, wherein the first end member 40 is installed in an end of the first chamber 31 and a seal ring 43 is located between the first end member 40 and an inside of the first chamber 31. The first end member 40 includes a first axle hole 401 and first escape holes 402. The first frame 42 is located between the first end member 40 and the first chamber 31 so that the first axle 41 is movable within a first inner space 420 of the first frame 42 and the first axle hole 401. The first frame 42 is a hollow body and includes the first inner space 420 and through holes 421, 4212, 423 which are respectively in communication with the main path 30, the upper path 32 and the second inlet 330 of the second chamber 33. Three seal rings 46 are mounted on the first frame 42 and a first seal ring 46 is located between the first frame 42 and the first inlet 310 of the first chamber 31. A second seal ring 46 is located between the first frame 42 and the first chamber 31. A third seal ring 46 is located between the first frame 42 and the first end member 40 so as to define two independent spaces in the first chamber 31.

The first axle 41 has a seal 44 and a seal ring 45 mounted thereto, wherein the seal 44 is movable between the three through holes 421, 422, 423 so as to control the communication between the entrance 320 of the upper path 32 and the first inlet 310 of the first chamber 31, and between the entrance 320 of the upper path 32 and the second inlet 330 of the second chamber 33.

The secondary valve unit 5 includes a second end member 50, a second frame 51 and a second axle 52. The second end member 50 includes a second inner space 501, a second axle hole 502 and second escape holes 503. The second end member 50 is installed in a free end of the second chamber 33 and a seal ring 58 is mounted on the second end member 50 and in contact with an inside of the secondary chamber 33. The second frame 51 and the second axle 52 are arranged and movable within the area between the second end member 50 to the second chamber 33 or the second end member 50. The second frame 51 includes an annular portion 511, a hollow axial passage 512 and guide holes 513, and a space 54 is defined between the annular portion 511 and the second end member 50 or the inside of the second chamber 33. The guide holes 513 communicate between the space 54 and the hollow axial passage 512. The seal ring 59 is mounted to the second axle 52 is movable along a hollow axial passage. 512 of the second frame 51 and within a second axle hole 502 of the secondary valve unit 5. The sealed the hollow axial 512 by the seal ring 59 decides the second frame 51 and the second axle 52 to have relative movement, or to decide the communication between the second chamber 33 and the handle 3. A spring 55 is connected between the annular portion n511 and the second chamber 33, and another spring 56 is connected between the second axle 52 and the second chamber 33. The second axle 52 can also be replaced by an end of the safety rod 6.

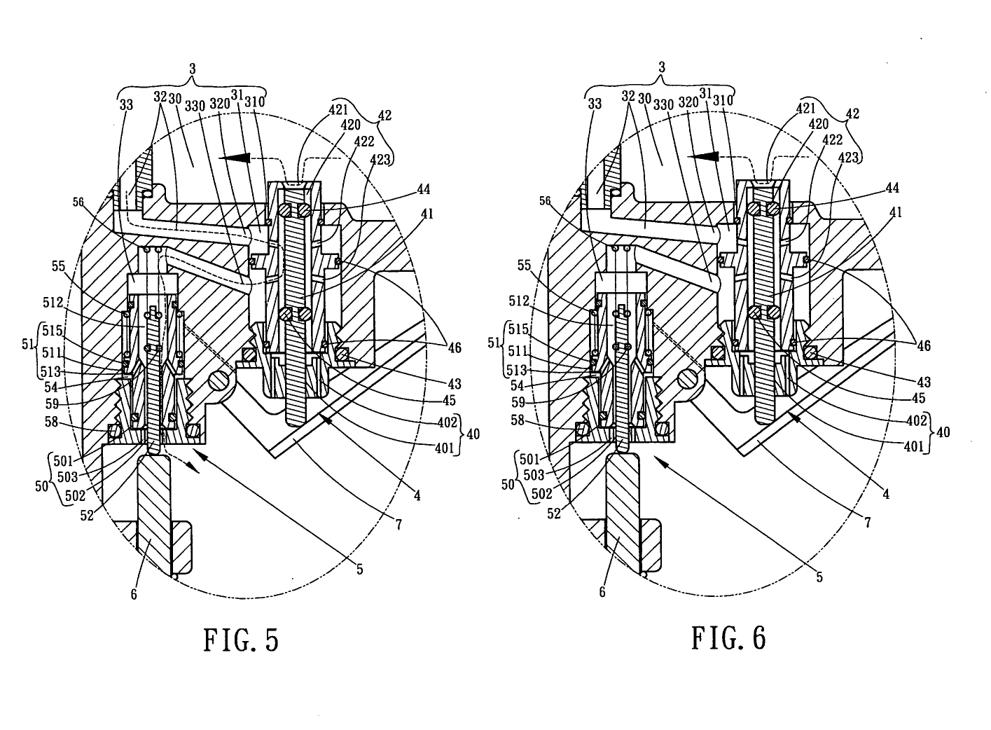

When operating the pneumatic nailer, the safety rod 6 is first pushed against an object so that the safety rod 6 moves upward as shown in FIG. 4, so that the seal ring 59 on the second axle 52 does not seal the hollow axial passage 512, and the second chamber 33 communicates with the handle 3. When pulling the trigger 7 and the firs axle 41 is pulled until the seal 44 moves over the through hole 422 and stops between the through holes 421 and 522. The seal ring 45 on the first axle 41 is moved to the first inner space 420 of the first frame 42. The two through holes 421, 422 are not in communication with each other, and the through hole 422 communicates with the through hole 423 as shown in FIG. 5. The compressed air in the main path 30 cannot enter the upper path 32 via the second inlet 320. The compressed air in the upper path 32 flows through the through holes 422, 423 and enters into the second chamber 33. The compressed air then escapes as shown in FIG. 6 because the seal ring 59 does not seal the hollow axial passage 512. The pressure in the upper path 32 is smaller than the pressure of the main path 30 so that the compressed air enters into the cylinder (not shown) to shoot the nail (not shown). If the safety rod 6 is moved back and then the trigger 7 is pulled, the compressed air in the main path 30 cannot enter into the upper path 32.

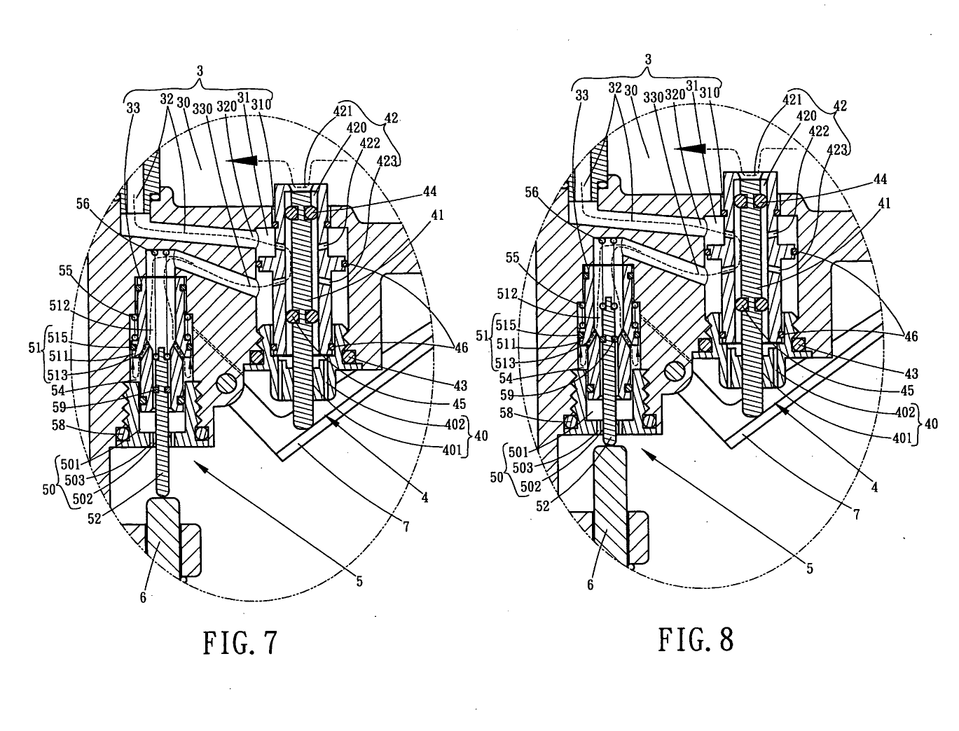

If the user first pulls the trigger 7 and moves the first axle 41, the seal 44 is moved upward and stays between the through holes 421, 422. The seal ring 45 on the first axle 41 is moved into the first inner space 420 of the first frame 42. In other words, the through holes 421, 422 are not in communication with each other, and the two through holes 422, 423 are in communication with each other. Therefore, the compressed air in the main path 30 cannot enter into the second inlet 320 of the upper path 32. The compressed air in the upper path 32 flows through the through holes 422, 423, and enters into the second chamber 33. The seal ring 59 seals the hollow axial passage 512 so that the air in the second chamber 33 enters the space 54 via the guide holes 513. The second frame 51 is moved upward as shown in FIG. 7 because the pressure becomes larger and larger in the space 54. The air located above the annular portion 511 escapes from another path 331. When the safety rod 6 is pulled upward, the seal ring 59 still seals the hollow axial passage 511 so that the second chamber 33 and the main path 30 are not in communication with each other as shown n FIG. 8. The nail cannot be ejected.

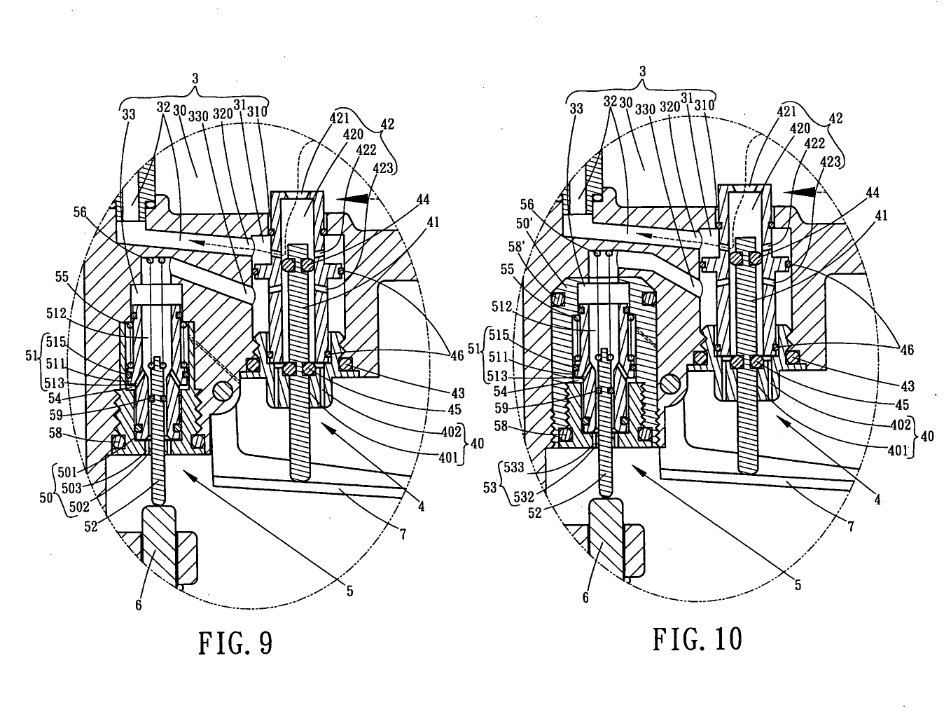

FIG. 9 shows another embodiment, wherein the length of the second inner space 501 of the second member 50 is increased and the seal ring 515 on the second frame 51 can be movable between the second inner space 501 and the second chamber 33. The space 54 is defined between the second frame 51 and the inside of the second end member 50.

FIG. 10 shows yet another embodiment, wherein the second end member 50 is replaced by the case 50′ and the third end member 53, wherein the case 50′ is installed in the free end of the second chamber 33 and a seal ring 58′ is located between the case 50′ and the inside of the second chamber 33. An inner surface of the case 50′ is connected with the third end member 53. The second frame 51 and the second axle 52 ARE located between the case 50′ and the third end member 53. The seal ring 59 on the second axle 52 is movable within the hollow axial passage 512 and the other end of the second axle 52 is movable in a third axial hole 532 of the third end member 53. The third end member 53 includes third escape holes 533 through which air escapes when the second chamber 33 is in communication with the main path 30.

While we have shown and described the embodiment in accordance with the present invention, it should be clear to those skilled in the art that further embodiments may be made without departing from the scope of the present invention.

What is claimed is:

1. A restriction mechanism for a pneumatic nailer, comprising:
a main path (30), a first chamber (31) and an upper path (32) defined in a handle (3), the first chamber (31) communicating with the main path (30) and the upper path (32), a second chamber (33) defined in the handle (3) and located beside the first chamber (31) and communicating with the first chamber (31);
a main valve unit (4) received in the first chamber (31) and including a first axle (41) on which a seal (44) is mounted, the first axle (41) being movable to move the seal (44) to seal an through hole (421) of the main valve unit (4), so as to control communication between an entrance (320) of the upper path (32) and a first inlet (310) of first chamber (31), and between the entrance (320) of the upper path (32) and a second inlet (330) of second chamber (33);
a secondary valve unit (5) received in the second chamber (33) and including a second end member (50), a second frame (51) and a second axle (52), the second end member (50) installed in a free end of the second chamber (33), a seal ring (58) mounted on the second end member (50) and being in contact with an inside of the secondary chamber (33), the second end member (50) including a second axle hole (502) and second escape holes (503), the second axle (52) having a seal ring (59) mounted thereto and being movable along a hollow axial passage (512) of the second frame (51) and within a second axle hole (502) of the secondary valve unit (5), and
the second frame (51) including an annular portion (511), the hollow axial passage (512) and guide holes (513), a seal ring (515) mounted to the annular portion (511) and a space (54) defined between the annular portion (511) and the second end member (50) or the inside of the second chamber (33), the second chamber (33) communicating with the hollow axial passage (512) via the guide holes (513), the seal ring (59) on the second axle (52) removably sealing the hollow axial passage (512) to control communication between the second frame (51) and the second axle (52).

2. The mechanism as claimed in claim 1, wherein the secondary valve unit (5) includes a case (50′), a third end member (53), a second frame (51) and the second axle (52), the case (50′) is installed in the free end of the second chamber (33) and a seal ring (58′) located between the case (50′) and the inside of the second chamber (33), an inner surface of the case (50′) is connected with the third end member (53), the second frame (51) and the second axle (52) located between the case (50′) and the third end member (53), the al ring (59) on the second axle (52) is movable within the hollow axial passage (512) and the other end of the second axle (52) is movable in a third axial hole (532) of the third end member (53), the third end member (53) includes third escape holes (533.

3. The mechanism as claimed in claim 1, wherein a spring (55) is connected between the second chamber (33) and the annular portion (511).

4. The mechanism as claimed in claim 1, wherein the second axle (52) is an end of a safety rod (6).

5. The mechanism as claimed in claim 3, wherein a spring (56) is connected between the second chamber (33) and the second axle (52).

6. The mechanism as claimed in claim 1, wherein the main valve unit (4) includes a first end member (40), a first axle (41) and a first frame (42), the first end member (40) is installed in an end of the first chamber (31) and a seal ring (43) is located between the first end member (40) and an inside of the first chamber (31), the first end member (40) includes a first axle hole (401) and first escape holes (402), the first frame (42) is located between the first end member (40) and the first chamber (31) so that the first axle (41) is movable within an first inner space (420) of the first frame (42) and the first axle hole (401), the first frame (42) is a hollow body and includes the first inner space (420) and through holes (421, 4212, 423) which are respectively in communication with the main path (30), the upper path (32) and the second inlet (330) of the second chamber (33), three seal rings (46) are mounted on the first frame (42) and a first seal ring (46) is located between the first frame (42) and the first inlet (310) of the first chamber (31), a second seal ring (46) is located between the first frame (42) and the first chamber (31), a third seal ring (46) is located between the first frame (42) and the first end member (40) so as to define two independent spaces in the first chamber (31).

7. The mechanism as claimed in claim 1, wherein the main valve unit (4) includes a first end member (40) and the first axle (41), the first end member (40) is installed in an end of the first chamber (31) and a seal ring (43) is located between the first end member (40) and an inside of the first chamber (31), the first end member (40) includes a first axle hole (401) and first escape holes (402), the first axle (41) is movable within the first axle hole (401).

8. The mechanism as claimed in claim 2, wherein the second frame (51) includes an annular potion (511), a hollow axial passage (512), and guide holes (513), the annular portion (511) includes a seal ring (515) mounted thereto and a space (54) is defined between a lower portion of the annular portion (511) and the third end member (53), the space (54) communicates with the hollow axial passage (512) via the guide holes (513).
